(19) United States
(12) Patent Application Publication
(10) Pub. No.: US 2005/0088866 A1
(43) Pub. Date: Apr. 28, 2005

(54) Portable power supply

(75) Inventor: Jonathan Levine, New York, NY (US)

Correspondence Address: KLARQUIST SPARKMAN, LLP, 121 SW SALMON STREET, SUITE 1600, PORTLAND, OR, 97204, US

(73) Assignee: Team Products International, Inc.

(21) Appl. No.: 10/928,457

(22) Filed: Aug. 27, 2004

Related U.S. Application Data
(60) Provisional application No. 60/498,910, filed on Aug. 29, 2003.

(51) Int. Cl. F02G 1/00

(52) U.S. Cl. 363/146

(57) ABSTRACT

Embodiments of portable power supplies are disclosed herein. One disclosed embodiment, for example, comprises a circuit configured to input an electrical power signal, modify at least one electrical characteristic of the power signal, and to output a modified power signal (e.g., a DC-AC inverter). The circuit is enclosed by and secured within a housing that includes an anchoring region adapted to interface with a cup holder. In certain implementations, the housing is substantially cup shaped.

### CROSS-REFERENCE TO RELATED APPLICATIONS

This application claims the benefit of U.S. Provisional Application No. 60/498,910, filed on Aug. 29, 2003. The entire disclosure of the provisional application is considered to be part of the disclosure of the following application and is hereby incorporated by reference.

### FIELD

This application relates to a portable power supply, such as a portable power inverter for converting a direct current into an alternating current.

### BACKGROUND

Electrical energy can be generated and distributed in a wide variety of manners. In mobile environments, batteries are typically relied on to produce an electrical current that powers one or more electrical devices. For example, in a typical automobile, a 12-volt battery is used to provide power for the starter, locks, radio, and lighting system of the vehicle. Often, however, the signal produced by a mobile power source is not compatible with all electrical devices that are desirably driven by the power source. This incompatibility typically results from one or more of the electrical characteristics of the power-source signal (e.g., the type of current (alternating or direct), voltage, or amperage) being incongruent with the operating requirements of the device to be powered. The typical 12-volt vehicle battery, for example, not only produces a different voltage than used by most devices (which operate using a 110/120-volt standard) but also produces a direct current (DC) instead of the standard alternating current (AC). Consequently, for such devices to operate, an intermediate power supply must be utilized that converts the power-source signal into a compatible form.

One such power supply is a power inverter, which creates an alternating current from a direct current. A common type of power inverter converts 12-volt direct current (e.g., from a vehicle battery) into a 110-volt, 60 Hz alternating current as may be used to power household electronics. Inverters can be particularly useful in recreational environments, where users often find themselves in locations where AC power is unavailable.

Compared to portable AC generators, power inverters are typically smaller, quieter, and more affordable. A typical power inverter, however, can be awkward to use in the confined spaces of the typical vehicle compartment. For example, a power inverter is usually placed on the floor of the vehicle (e.g., next to the passenger's feet in an automobile) where it lies unsecured during use. Thus, not only is the inverter intrusive, but it is susceptible to damage caused by vehicle or passenger movement. Further, the surface of a typical inverter becomes very hot after use, making it difficult or impractical to move until a sufficient cooling period has passed.

### SUMMARY

Disclosed below are representative embodiments of portable power supplies that should not be construed as limiting in any way. Instead, the present disclosure is directed toward all novel and nonobvious features, aspects, and combinations thereof of the various disclosed embodiments, alone and in various combinations and subcombinations with one another. The disclosed technology is not limited to any specific aspect or feature, or combination thereof, nor do the disclosed embodiments require that any one or more specific advantages be present or problems be solved.

One disclosed embodiment comprises a circuit configured to modulate a power signal (e.g., a DC-AC inverter) and a housing that substantially encloses the circuit. In this embodiment, at least a portion of the housing is configured to be received by and secured within a beverage-container receptacle (e.g. a vehicle cup holder). The device further includes an electrical interface on an exterior surface of the housing. The electrical interface (e.g., an electrical socket) provides an electrical coupling between the circuit and an external electrical device. In certain implementations, additional electrical interfaces are provided. The device may further comprise a so-called input electrical interface (e.g., a cord and cigarette-lighter adapter) configured to electrically couple the circuit with a power source. The housing can be substantially cup shaped and may further comprise a substantially planar bottom end on which the housing can be set in a balanced, upright position. In certain embodiments, the device further comprises a fuse located within and accessible through a removable portion of the housing. The housing may also comprise one or more vents between the interior of the housing and the external environment. In certain implementations, a cooling fan is secured within the housing and positioned between the vent and the circuit (e.g., in a region of the housing substantially opposite the portion of the housing that is receivable by and securable within the beverage-container receptacle).

Another disclosed embodiment comprises a circuit configured to receive an input signal such as an electrical power signal, modify at least one electrical characteristic of the power signal, and to provide an output signal, such as a modified power signal (e.g., a DC-AC inverter). The circuit is enclosed by and secured within a housing that includes an anchoring region adapted to interface with a cup holder. In certain implementations, the housing is substantially cup shaped. The housing may also have the shape of a solid of revolution about a central longitudinal axis that includes a planar region on which an electrical interface is located. In some implementations, the anchoring region is prismatic, frustoconical, or cylindrical in shape. Moreover, in certain specific implementations, the anchoring region terminates at a generally planar end region on which the housing can be set in a balanced, upright position and/or that has a greatest transverse dimension less than or equal 2.6 inches.

In another disclosed embodiment, a power-inverter housing comprises an upper portion and a lower portion. The lower portion of the housing is shaped substantially as a cylinder, prism, or conical frustum, and has a greatest transverse dimension across a majority of the lower portion that is less than or equal to 3⅜ inches. Further, one or more electrical interfaces are located on an exterior surface of the upper portion of the housing. The electrical interfaces are adapted to electrically couple with and provide an alternating current to an external electrical device. In some implementations, the greatest transverse dimension across a majority of the lower portion is less than or equal to 2.6 inches. Similarly, in certain implementations, the lower portion of the housing is shaped as cylinder or conical frustum, and the majority of the lower portion has a diameter less than or equal to 2.6 inches. The lower portion of the housing may have a height that is greater than or equal to 2.5 inches. Further, the housing can be substantially cup shaped, or otherwise substantially symmetrical about a longitudinal central axis. In certain implementations, the lower portion of the housing fits securely within a beverage-container receptacle. In certain embodiments, the device further comprises a cooling fan secured within the upper portion of the housing adjacent an upper surface of the housing, the upper surface of the housing further comprising one or more vents.

The foregoing and additional features and advantages of the disclosed embodiments will become more apparent from the following detailed description, which proceeds with reference to the following drawings.

### BRIEF DESCRIPTION OF THE DRAWINGS

FIG. 1 is a front and right side perspective view of a first exemplary embodiment of the disclosed power supply.

FIG. 2 is a front elevational view of the embodiment illustrated in FIG. 1.

FIG. 3 is a top plan view of the embodiment illustrated in FIG. 1.

FIG. 4 is a bottom plan view of the embodiment illustrated in FIG. 1.

FIG. 5 is a right side elevational view of the embodiment illustrated in FIG. 1.

FIG. 6 is a rear elevational view of the embodiment illustrated in FIG. 1.

FIG. 7 is a front elevational view of an alternative implementation of the power supply shown in FIG. 1, which has additional vents and a cover for the electrical interface on the front of the housing.

FIG. 8 is rear elevational view of the power supply illustrated in FIG. 7 showing additional vents on the rear surface of the housing.

FIG. 9 is an exploded perspective view illustrating the construction of the housing of the embodiment illustrated in FIG. 1.

FIG. 10 is a circuit diagram of an exemplary circuit as may be used in the power supply illustrated in FIG. 1.

FIG. 11 is a circuit diagram of an exemplary circuit as may be used in the power supply illustrated in FIG. 12

FIG. 12 is a front and left side perspective view of a second exemplary embodiment of the disclosed power supply.

FIG. 13 is a front elevational view of the embodiment illustrated in FIG. 12.

FIG. 14 is a right elevational view of the embodiment illustrated in FIG. 12.

FIG. 15 is a rear elevational view of the embodiment illustrated in FIG. 12.

### DETAILED DESCRIPTION

For illustrative purposes only, the disclosed technology is shown and described as being implemented as a power inverter. This particular function should not be construed as limiting in any way, as the disclosed technology may alternatively perform other electrical functions or combinations thereof. The function of the disclosed power supply can generally be described as receiving an input power signal, modifying at least one electrical characteristic of the power signal (e.g., voltage, current, phase, or a combination thereof), and providing an output signal such as a modified power signal. In this way, the power supply can modulate a power signal received from a power source and provide a modulated power signal to one or more external electrical devices.

For example, embodiments of the disclosed device (referred to generally as a power supply) may comprise: (1) a DC-AC inverter for producing alternating current from direct current; (2) an AC-DC converter (sometimes referred to as a rectifier) used, for instance, to charge a vehicle's battery or otherwise produce direct current; (3) a DC-DC regulator (e.g., a DC transformer) used to filter direct current or to produce a direct current having desirable electrical characteristics; or (4) an AC-AC regulator (e.g., an AC transformer) used to filter alternating current or to produce an alternating current having desirable electrical characteristics. Embodiments of the disclosed portable power supply can also perform combinations of these functions. For instance, one exemplary embodiment can selectively operate as both a DC-AC inverter and an AC-DC converter.

The disclosed power supply is similarly not limited to any particular interface used to electrically couple the internal circuitry of the portable power supply with an external power source (referred to generally as an output electrical interface) or interface used to electrically couple the internal circuitry to an external device to be powered (referred to generally as an input electrical interface).

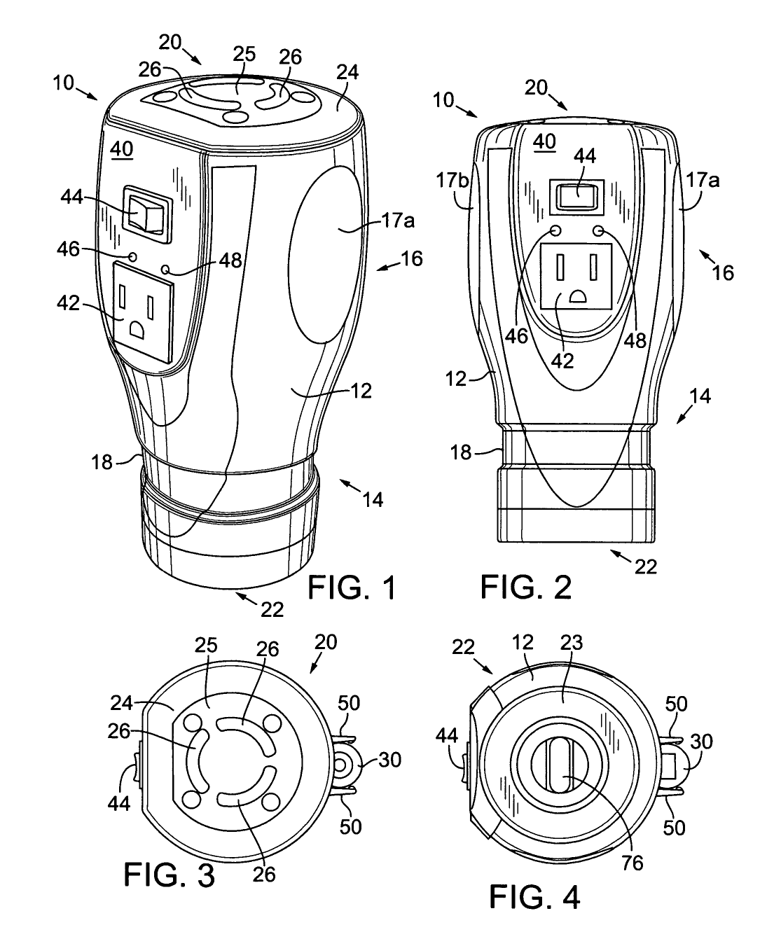

FIG. 1 shows a perspective view of a representative embodiment of a power supply 10 according to the disclosed technology. In this embodiment, a housing 12 of the power supply 10 has a generally cylindrical shape. The housing 12 includes a lower portion 14 having a smaller diameter than an upper portion 16. In the illustrated embodiment, the housing 12 is shaped to retain a generally cup-like appearance and tapers smoothly toward the narrower lower portion 14.

In certain embodiments, a majority of the lower portion 14 is configured to fit securely within a beverage-container receptacle (such as a vehicle cup holder dimensioned for standard aluminum cans, coffee mugs, large drink containers, thermoses, and other such receptacles). In these embodiments, the lower portion 14 fits within the receptacle such that only minor lateral movement of the power supply is possible within the receptacle. Thus, the lower portion 14 can be described as anchoring, or securing, the power supply 10 within the receptacle. The exemplary shape of the power supply 10 illustrated in FIG. 1 further allows the power supply 10 to be easily held in a single hand of the user and creates a pleasing, low-profile appearance when placed in a beverage-container receptacle or vehicle cup holder.

The beverage-container receptacle for which the lower portion 14 of the housing 12 is configured can more generally comprise any receptacle for a liquid container, such as a bottle, can, cup, mug, travel-mug, thermos, flask, glass, jar, canteen, or other liquid-bearing vessel. According to certain embodiments of the power supply 10, however, the greatest transverse dimension in a majority of the lower portion 14 (e.g., the greatest distance between two opposing points on a cross-section of the lower portion) is less than or equal to 2.6 inches. Further, in certain embodiments the lower portion 14 has a height of at least 2 inches. These dimensions may vary from implementation to implementation depending on the receptacle for which the power supply 10 is designed (e.g., a 3⅜ inch-diameter receptacle).

The particular shape of the housing 12 shown in FIG. 1 should not be construed as limiting in any way, as the housing may have a variety of shapes without departing from the scope of this disclosure. For example, the housing 12 may have a cylindrically shaped lower portion 14 (either a circular or elliptical cylinder) dimensioned to fit within a cup holder, whereas the upper portion 16 may have a non-cylindrical shape (e.g., a box, polygon, prism, etc.). Alternatively, the lower portion 14 may not be cylindrical, but may nevertheless be dimensioned to fit within a cupholder. For example, the lower portion 14 may have the shape of a conical frustrum or prism (e.g., right prism having three or more faces). Moreover, any corners of the lower portion 14 may be rounded or tapered. For certain embodiments, the housing 12 is characterized as having the shape of a solid of revolution about a central longitudinal axis that further includes a planar region on which one or more output electrical interfaces are located.

The housing 12 of the power supply 10 may be manufactured from a suitably rigid material that protects the internal electrical components from the surrounding environment. For instance, in one embodiment, the housing 12 is manufactured from a hard polymer (e.g., plastic, polyethylene, polypropylene, or other such polymers). In such embodiments, the housing 12 can be manufactured using a variety of techniques (e.g., injection molding) and formed from two halves that are adhesively or frictionally sealed, or sealed using one or more fasteners (e.g., screws). In other embodiments, however, other suitable materials are used to manufacture the housing 12 (e.g. metal, rubber, etc.).

Also shown in FIG. 1 is a first grip portion 17a located on one side of the housing 12. As shown in FIG. 2, a second grip portion 17b can be located on an opposing side of the housing 12. The grip portions 17a, 17b can be constructed of a rubber material having a softer, more tactile feel, than the remainder of the housing 12. The grip portions 17a, 17b can alternatively comprise textured gripping surfaces having, for example, impressions or indentations (e.g., a dimpled surface), a coating that increases friction, or a coating that has a tacky surface. Certain embodiments of the housing 12 lack the grip portions 17a, 17b entirely. The grip portions 17a, 17b can have a variety of different dimensions and shapes depending on the implementation (e.g., a single band comprising the gripping surface). The number of grip portions on the housing 12 may similarly vary.

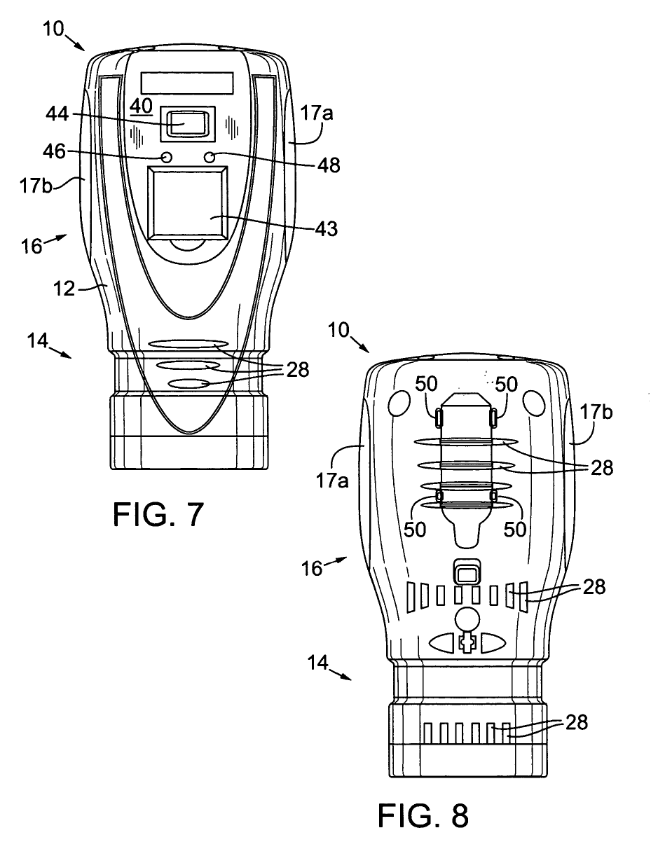

The exemplary housing 12 shown in FIG. 1 further includes a top end 20 and a bottom end 22. As shown in FIG. 3, the top end 20 may comprise a top panel 25. For example, in the illustrated embodiment, the top panel 25 is coupled to an internal, compact fan (described below) and held in place by a lip portion 24 of the housing that extends over a flanged edge of the top panel 25. The top end 20 may further include multiple vents 26 used to cool and ventilate the power supply 10 during operation. The vents 26 can be located in various other positions on the housing 12 including, or instead of, the top panel 25. For example, as shown in FIG. 7, additional vents 28 may be located on a front side of the housing 12, or, as shown in FIG. 8, on the back side of the housing. In general, it is desirable to locate the vents 26, 28 in positions where ventilation is not impeded. Thus, for example, because the lower portion 14 of the housing 12 may be enclosed by a surrounding cup holder, the lower portions of certain embodiments do not contain any vents. In certain other embodiments, however, vents are located in the lower portion 14 of the housing 12 (as in vents 28 on FIG. 7 and a portion of the vents 28 in FIG. 8).

The top end 20 of the housing 10 may include a handle (not shown) pivotally connected at opposite sides of the top end. The housing 12 may be further shaped such that the handle rests flush with the sides of the housing 12 and the top end 20 when not in use. Although the handle may be hinged at its ends, it may alternatively be fixed at a single position on the housing 12 or be completely absent.

The embodiment illustrated in FIG. 1 further includes a planar surface 40 on which various components of the power supply 10 are located. For example, in the exemplary embodiment shown in FIG. 1, the planar surface 40 includes an electrical interface 42 (e.g., a socket or outlet), a switch 44, and monitoring lights 46, 48.

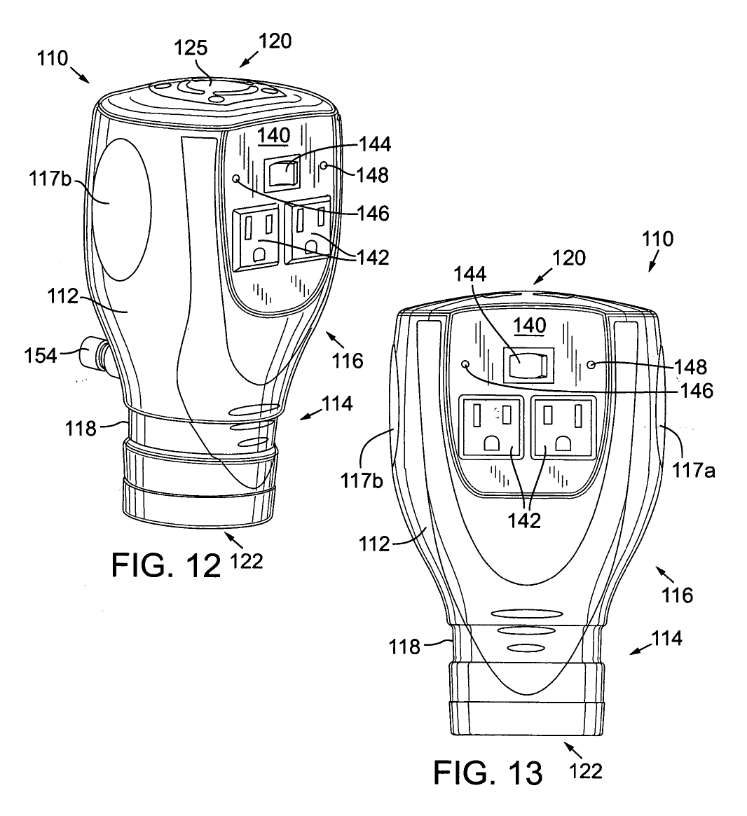

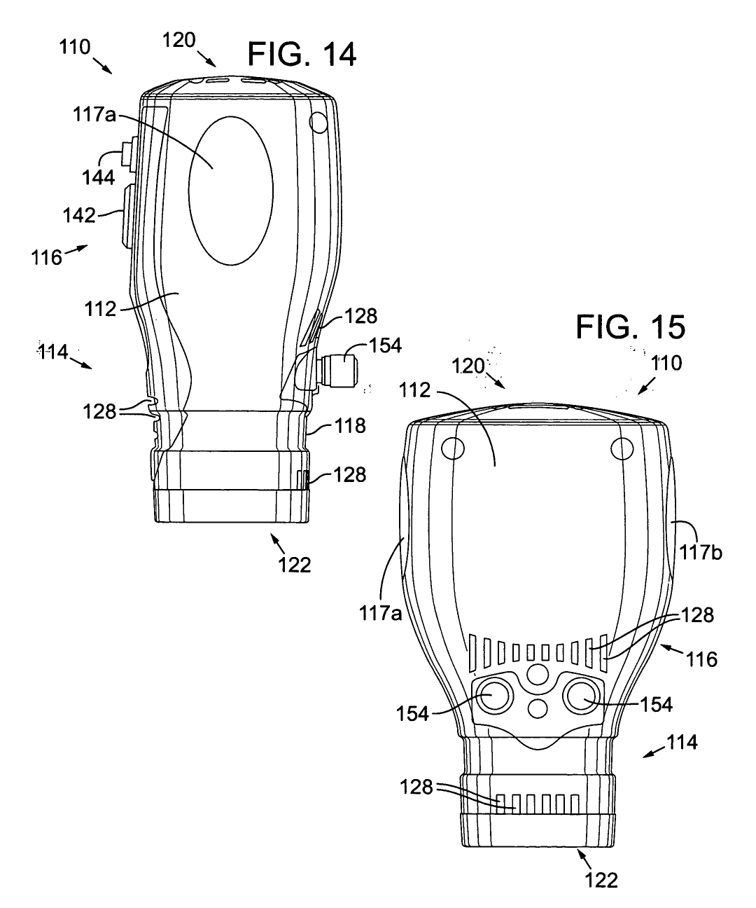

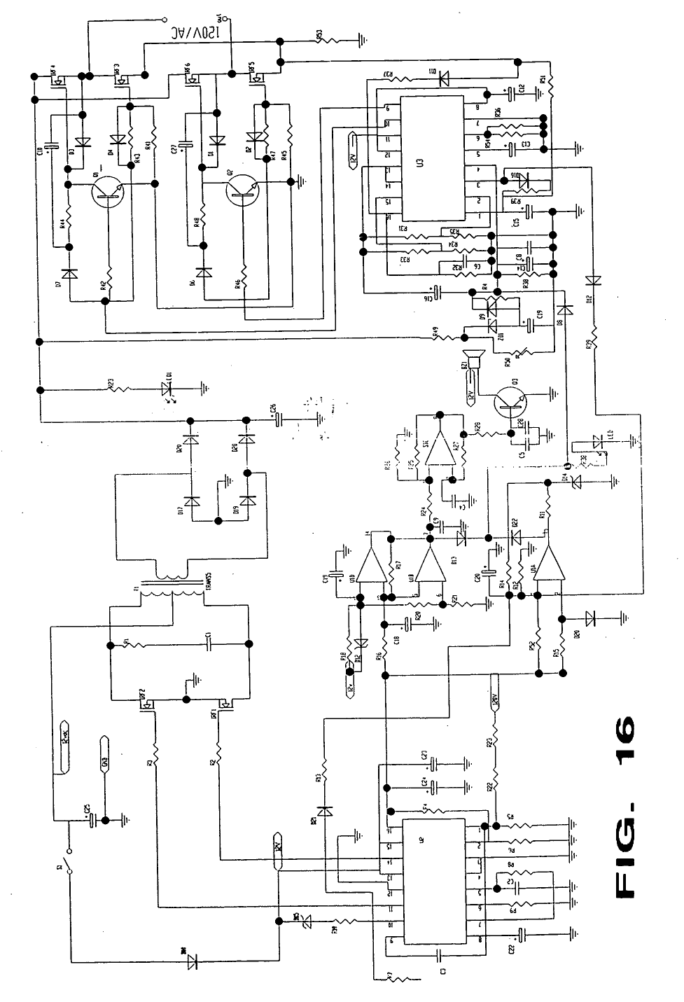

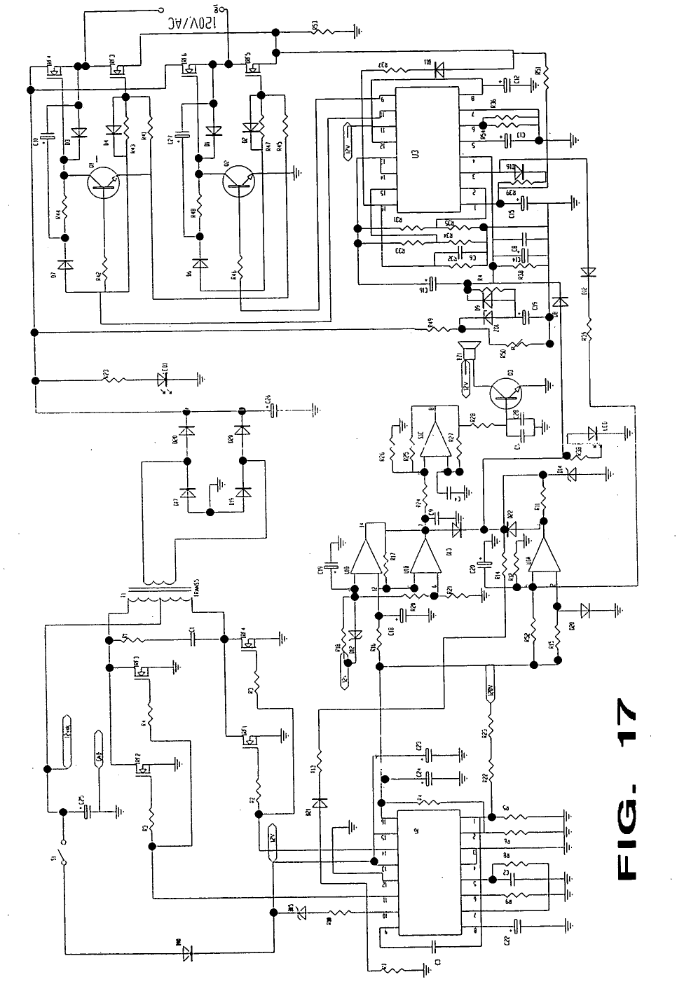

FIG. 2 shows a front view of the exemplary power supply 10 and shows the planar surface 40 in greater detail. In the illustrated embodiment, the electrical interface 42 is a standard three-prong socket configured to receive a grounded three-prong plug. The electrical interface 42, however, may be configured for various other couplings or standards. For instance, the electrical interface 42 may be configured to receive a plug according to a different international or proprietary electrical standard, usually having at least two prongs. Multiple additional electrical interfaces 42 may be located on the planar surface 40 or elsewhere on the power supply. For example, the power supply 10 may have two electrical outlets vertically or horizontally displaced from one another on the planar surface 40 (see, for example, FIGS. 12-15 and the accompanying discussion below).

The electrical interface 42 may further include a cover (not shown in FIGS. 1 and 2) that protects the interface from the external environment (e.g., rain, dust, etc.). In one particular embodiment, the cover is a rubber cover pivotally attached to a point adjacent the interface 42. The cover may further include a projection dimensioned to fit into one of the apertures of the interface 42 (e.g., into the ground aperture), thereby frictionally affixing the cover to the interface. For example, FIG. 7 shows an embodiment of the power supply 10 wherein a cover 43 covers the electrical interface 42.

FIG. 2 also shows status indicators 46, 48 on the planar surface 40. In the illustrated embodiment, status indicator 46 is a light that is activated when the power supply 10 is in operation, and status indicator 48 is a light that is activated when there is a malfunction in the operation of the power supply. A switch 44 on the planar surface 40 is also shown in the embodiment illustrated in FIGS. 1-4. The switch 44 can be selectively toggled between an “on” and “off” position. The switch 44 may comprise any suitable electrical switch for selectively activating the power supply 10 (e.g., a push-button switch, lever switch, tact switch, etc.). The particular components shown on the planar surface 40 of the housing 12 are not limiting in any way. Instead, various other components may be included on the planar surface 40 or elsewhere on the housing 12.

In some embodiments, a digital display may be included on the planar surface 40 that displays information about selected electrical characteristics of the power supply 10 (e.g., voltage, current, or wattage at the input and/or output of the power supply). Certain embodiments, however, do not include the switch 44 and/or the status indicators 46, 48. In other embodiments, the electrical components are not positioned on any distinct side surface of the housing 12. For instance, any or all of the components may be located on the top end 20 or as part of the exterior surface of the housing 12. In still other embodiments, the power supply 10 may include multiple planar surfaces on which the various components are located in various combinations and subcombinations with one another. For instance, the power supply 10 may have multiple electrical interfaces 42, each one of which is located on a separate planar surface of the housing 12.

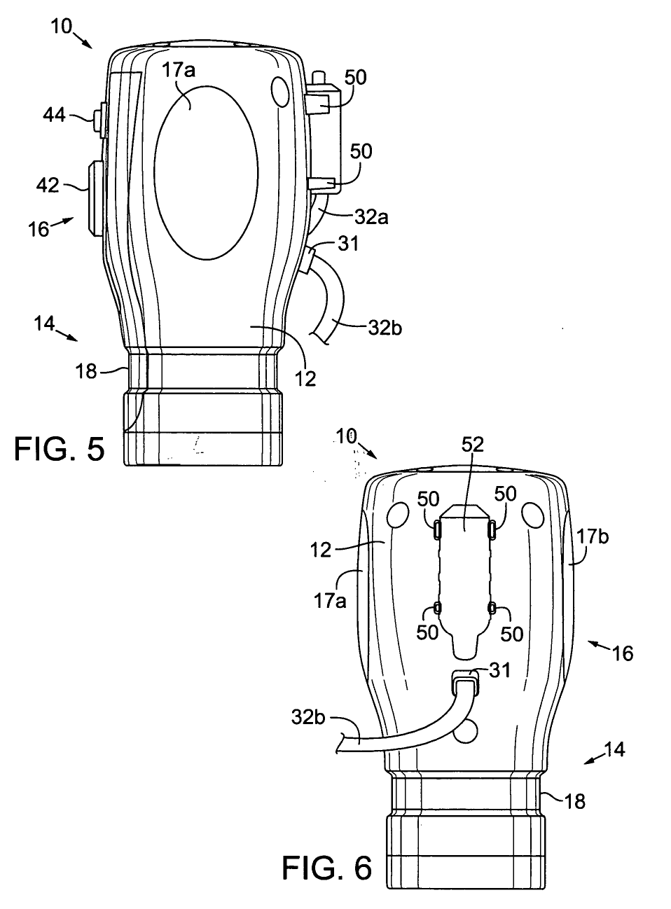

FIG. 5 shows a side image of the exemplary embodiment of FIG. 1. As seen in FIG. 5, the power supply 10 further includes portions 32a, 32b of an electrical cord 32 that extend from the housing 12 and terminate at an adapter plug 30. An insertion point 31 of the cord 32 into the housing 12 may be located so that it does not interfere with the fit of the power supply 10 within a beverage-container receptacle. For instance, the insertion point 31 may be on, or near, the top end 20 of the housing 12. Further, when not in use, the cord 32 can be wrapped around a channel region 18 of the housing 12, which comprises an annular indentation of the housing that prevents the wrapped cord from slipping off the bottom end 22. In general, the cord 32 and adapter plug 30 form an electrical interface that electrically couples the internal circuit of the power supply 10 with an external power source (such as a vehicle battery). Thus, in the illustrated embodiment, the electrical interface formed by the cord 32 and adapter 30 can be viewed as the input to the power supply 10, whereas the electrical interface 42 on the opposing front side of the power supply 10 can be viewed as the output of the power supply.

In the particular embodiment illustrated in FIG. 1, the adapter 30 is a 12-volt adapter plug configured to fit within a standard cigarette lighter. In alternative embodiments, however, the input electrical interface formed by cord 32 and adapter plug 30 may be configured to electrically couple to the power source through a variety of different electrical couplings. For example, in the embodiments discussed below with respect to FIGS. 12-15, positive and negative binding posts 154 form the electrical interface with the power source. In general, the binding posts 154 allow heavier gauge electrical wire to be used to conduct the power signal from the power source (e.g., a 12-volt automobile battery) into the power supply 10. Thus, electrical devices drawing larger loads (e.g., 500 watts or greater) can be powered by the power supply 10.

FIG. 5 also shows clips 50 of the housing 12 configured to receive and secure the adapter plug 30 against the housing when the adapter is not in use. FIG. 6 shows a rear view of the exemplary embodiment from FIG. 1 showing the clips 50 in greater detail. In FIG. 6, the adapter has been removed from the clips 50, revealing a recess portion 52 of the housing configured to partially surround the adapter when it is engaged by the clips. The recess 52 allows the adapter 30 to sit more flush against the housing 12 and reduces the likelihood of the adapter being easily disengaged from the clips 50.

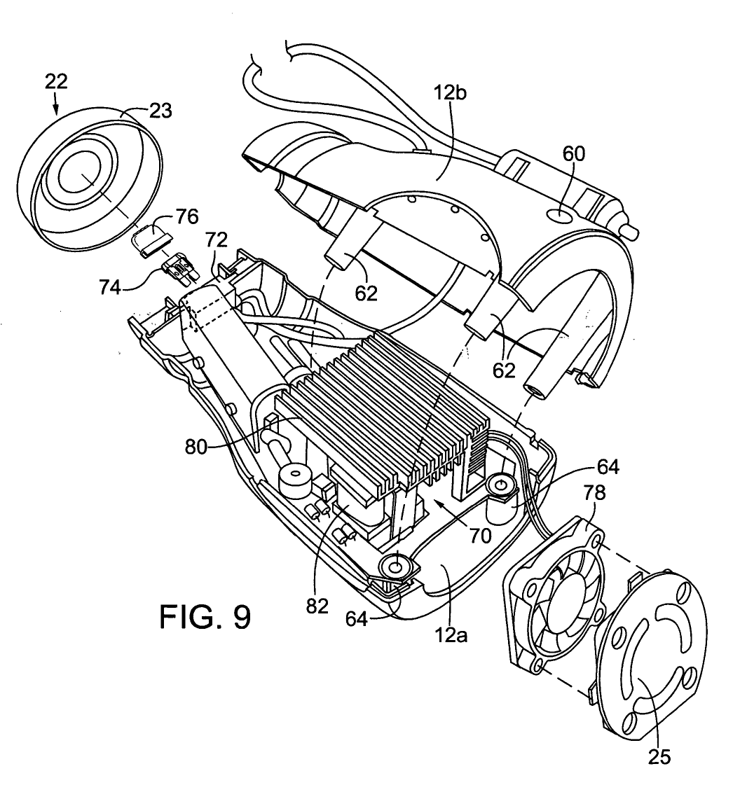

FIG. 9 is an exploded perspective view showing the construction of the exemplary embodiment of FIG. 1 in greater detail. As seen in FIG. 9, the illustrated housing 12 comprises a back half 12b and a front half 12a that separate the housing 12 into two substantially symmetrical halves along the power supply 12's longitudinal axis. The two halves 12a, 12b are coupled to one another via fasteners (e.g., screws) that extend into apertures 60 on the back half 12b, through connecting posts 62 (which may be formed integrally with the back half) and into receiving posts 64 of the front half 12a. The fasteners may similarly extend through eyelets of a circuit 70 located between the connecting posts 62 and the receiving posts 64. In this manner, the circuit 70 can be secured within the housing 12. This particular means of fastening the halves 12a, 12b should not be construed as limiting, however, as the halves may be coupled together through a variety of means (e.g., adhesively, frictionally, using one or more snap fittings, or other such fastening means).

A separate bottom cover 23 that forms part of the housing 12 is also shown in FIG. 9. The bottom cover 23 is additionally shown in FIG. 4. In certain embodiments, the bottom cover 23 forms a generally planar bottom surface on which the housing 12 can be placed in an upright, balanced position. In certain other embodiments, the bottom cover 23 is integrated in the housing 12. The bottom cover 23 may be manufactured from a more elastomeric material (e.g., a natural rubber or elastic polymer) than the remainder of the housing 12, thereby providing additional stability and cushioning to the power supply 10 when the power supply is placed in a cup holder. The material that comprises the bottom cover 23 may also be a highly insulative material that protects the internal electrical components of the power supply 10 from potential shorts that could damage the power supply.

In certain embodiments, the bottom cover 23 is frictionally attached to the bottom of the housing and can be easily removed to allow greater access to one or more components of a circuit 70. For example, as illustrated in FIG. 9, the bottom end 22 of the circuit 70 comprises a fuse compartment 72 into which a fuse 74 can be placed, thereby protecting the power supply 10 from overloading. A fuse cover 76 may also be included.

In general, the circuit 70 comprises an electrical circuit adapted to perform the desired power signal modulation. For example, the circuit 70 may be an AC-DC converter, a DC-AC inverter, a DC-DC regulator, an AC-AC regulator, or any combination thereof. In the illustrated embodiment, for instance, the circuit 70 comprises a printed circuit board having components configured to function as a DC-AC inverter for converting a 12-volt DC power signal into a 110-volt, 60 Hz, AC power signal having a modified sine wave and a maximum continuous power of 200 Watts. Power inversion circuits are well known in the art and need not be described in detail herein. Such power inversion circuits as may comprise the circuit 70 can be configured to produce a variety of waveforms (e.g., a pure sine wave) and have a wide range of other electrical characteristics (e.g., various maximum continuous powers, peak powers, input voltage ranges, amperages, and the like).

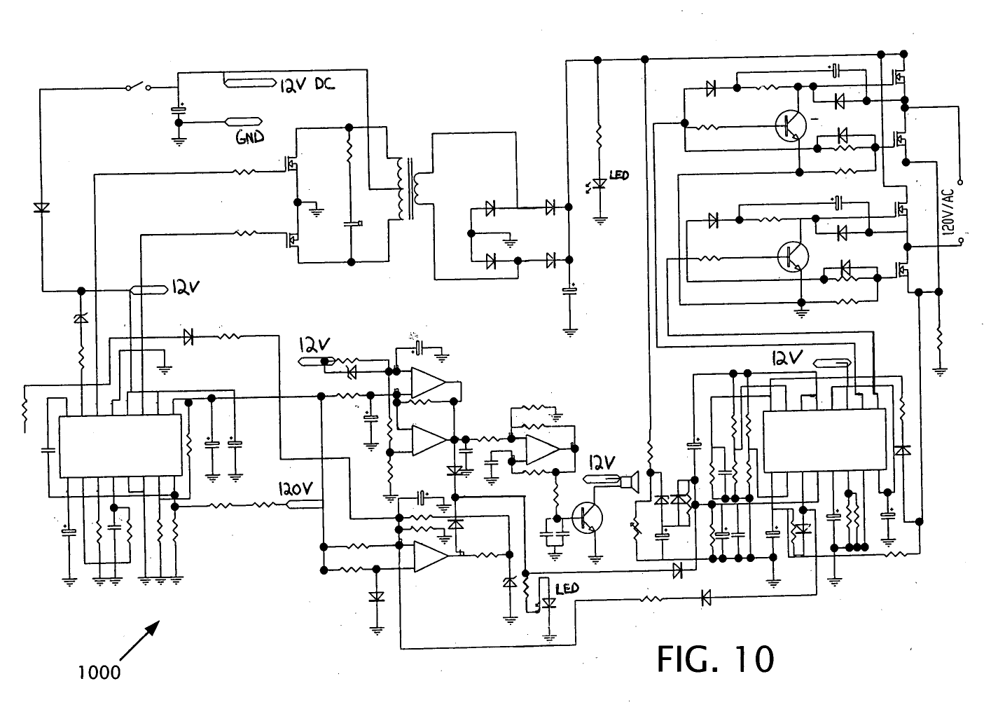

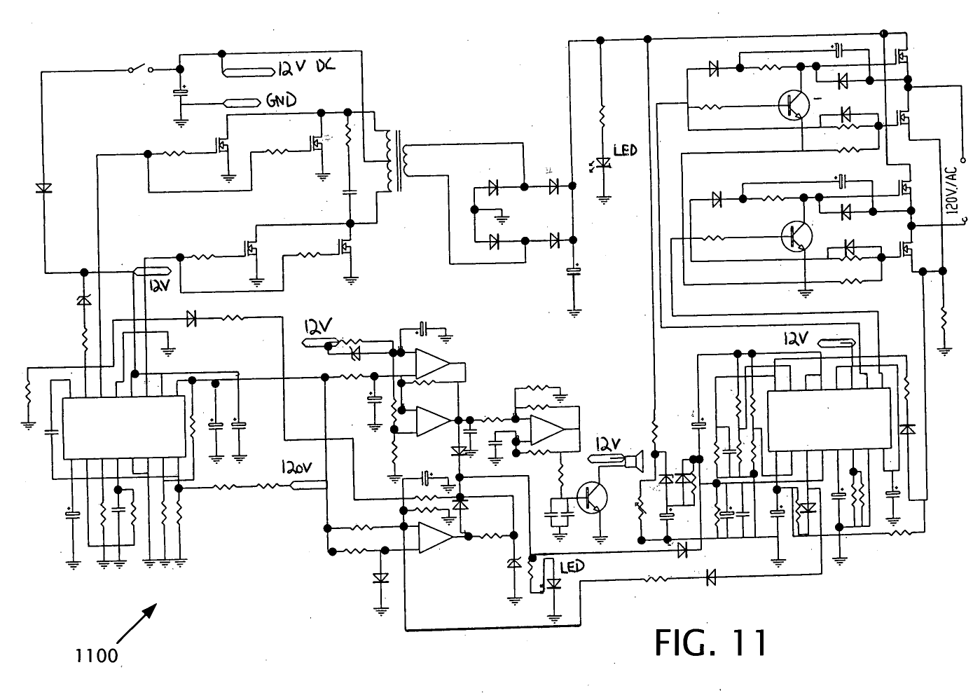

FIG. 10 is a circuit diagram 1000 showing an exemplary circuit 70 for converting direct current into alternating current at a single electrical interface (as in the power supply illustrated in FIGS. 1-9). Similarly, FIG. 11 is a circuit diagram 1100 showing an exemplary circuit for converting direct current into alternating current at two electrical interfaces (as in the power supply illustrated in FIGS. 12-15, discussed below).

The electrical components comprising the circuit 70 should desirably be selected such that the circuit is compact and fits within the housing 12. For example, in the embodiment illustrated in FIG. 9, a heat sink 80 includes a folded portion that extends over a transformer 82. In order to help cool the components of the circuit 70 during operation of the power supply 10, a fan 78 can be located between components of the power supply 10 that generate heat and vents in the housing 12. For example, in the illustrated embodiment, a fan 78 is located between a heat sink 80 of the circuit 70 and the top cover 26, which has multiple vents. Also, in the illustrated embodiment, the fan 78 is coupled directly to the top cover 26 and sits in direct physical contact on the heat sink 80. In this and similar configurations, the fan 78 is positioned in a region of the power supply 10 not likely to be confined or constricted by the cup holder. In some embodiments, for example, the fan 78 is positioned on the side of the exterior surface of the upper portion 16 of the housing 12. In such configurations, the airflow created by the fan is unimpeded, and the cooling capacity of the fan 78 is increased.

FIGS. 12-15 illustrate another representative embodiment 110 of the disclosed portable power supply. Features in FIGS. 12-15 that are analogous to features in FIGS. 12-15 are incremented by 100. In the embodiment illustrated in FIGS. 12-15, a housing 112 comprises a planar surface 140 on which two electrical interfaces 142 are located. The two electrical interfaces 142 are configured to electrically couple the power supply 112 to two external electrical devices, and thus comprise output electrical interfaces. In the illustrated embodiment, the two electrical interfaces 142 comprise two three-prong sockets, but in alternative embodiments may comprise a variety of couplings.

Terminals 154 (FIG. 12) are positioned on a back side of the housing 112 and comprise an interface configured to electrically couple the power supply to an external power source (an input electrical interface). The terminals 154 allow the power supply 110 to receive a higher-power signal than can typically be received through the cord 32 and adapter 30 of the embodiment described above with respect to FIGS. 1-9.

Having illustrated and described the principles of the illustrated embodiments, it will be apparent to those skilled in the art that the embodiments can be modified in arrangement and detail without departing from such principles. For example, any of the embodiments described herein can further comprise additional electronic components integrated within the housing (e.g., radio, digital music player, TV, alarm clock, light, compressor, rechargeable battery, and the like). In view of the many possible embodiments, it will be recognized that the illustrated embodiments include only examples and should not be taken as a limitation on the scope of the invention. Rather, the invention is defined by the following Claims. I therefore claim as the invention all such embodiments and their equivalents that come within the scope of these Claims.

1. A portable power supply, comprising:
a circuit configured to modulate a power signal;
a portable housing that substantially encloses the circuit, at least a portion of the housing being configured to be received and secured within a beverage-container receptacle; and
at least one electrical interface in electric communication with the circuit and located on an exterior surface of the housing,
the at least one electrical interface being accessible from the exterior of the housing and adapted to electrically couple the circuit with an external electrical device.

2. The portable power supply of claim 1, wherein the at least one electrical interface comprises an electrical socket configured to receive a plug having at least two prongs.

3. The portable power supply of claim 1, wherein the at least one electrical interface comprises two electrical sockets configured to respectively receive plugs having at least two prongs.

4. The portable power supply of claim 1, wherein the at least one electrical interface comprises at least one output electrical interface, the device further comprising at least one input electrical interface configured to electrically couple the circuit with a power source, thereby providing power to the circuit.

5. The portable power supply of claim 4, wherein the at least one input electrical interface comprises a cord coupled with an adapter, the adapter being insertable within a vehicle cigarette lighter.

6. The portable power supply of claim 1, wherein the circuit is a DC-AC power inverter.

7. The portable power supply of claim 1, wherein the housing is substantially cup shaped.

8. The portable power supply of claim 1, wherein the housing further comprises a substantially planar bottom end on which the housing can be set in a balanced, upright position.

9. The portable power supply of claim 1, wherein the beverage-container receptacle is a vehicle cup holder.

10. The portable power supply of claim 1, further comprising a fuse located within and accessible through a removable portion of the housing.

11. The portable power supply of claim 1, wherein the housing further comprises one or more vents, the vents placing the interior of the housing into fluid communication with the external environment.

12. The portable power supply of claim 11, further comprising a cooling fan secured within the housing and positioned between the vent and the circuit.

13. The portable power supply of claim 12, wherein the vent and the cooling fan are located in a region of the housing substantially opposite the portion of the housing that is receivable by and securable within the beverage-container receptacle.

14. A portable power supply, comprising:
a circuit configured to input an electrical power signal, modify at least one electrical characteristic of the power signal, and to output a modified power signal;
a housing that substantially encloses and secures the circuit;
the housing including an anchoring region adapted to interface with a cup holder.

15. The portable power supply of claim 14, wherein the circuit is a power inverter for creating an alternating current from a direct-current power source.

16. The portable power supply of claim 14, wherein the housing is substantially cup shaped.

17. The portable power supply of claim 14, wherein the housing has a shape of a solid of revolution about a central longitudinal axis that includes a planar region on which an electrical interface is located, the electrical interface being adapted to electrically couple with an external electrical device.

18. The portable power supply of claim 14, wherein the anchoring region is prismatic in shape.

19. The portable power supply of claim 14, wherein the anchoring region is frustoconical in shape.

20. The portable power supply of claim 14, wherein the anchoring region is cylindrical in shape.

21. The portable power supply of claim 14, wherein the anchoring region terminates at a generally planar end region having a greatest dimension less than or equal 2.6 inches.

22. The portable power supply of claim 14, wherein the anchoring region terminates at a generally planar end region on which the housing can be set in a balanced, upright position.

23. A power inverter, comprising:
a power-inverter housing comprising an upper portion and a lower portion,
the lower portion of the housing being shaped substantially as a cylinder, prism, or conical frustum, wherein the greatest transverse dimension across a majority of the lower portion is less than or equal to 3⅜ inches; and
one or more electrical interfaces located on an exterior surface of the upper portion of the housing,
the one or more electrical interfaces being adapted to electrically couple with and provide an alternating current to an external electrical device.

24. The power inverter of claim 23, wherein the greatest transverse dimension across a majority of the lower portion is less than or equal to 2.6 inches.

25. The power inverter of claim 23, wherein the lower portion of the housing is shaped as cylinder or conical frustum, and wherein the majority of the lower portion has a diameter less than or equal to 2.6 inches.

26. The power inverter of claim 23, wherein the lower portion of the housing has a height greater than or equal to 2.5 inches.

27. The power inverter of claim 23, wherein the lower portion of the housing terminates at a generally planar end region on which the housing can be set in a balanced, upright position.

28. The power inverter of claim 23, wherein the housing is substantially cup shaped.

29. The power inverter of claim 23, wherein the housing is substantially symmetrical about a longitudinal central axis.

30. The power inverter of claim 23, wherein the lower portion of the housing is configured to fit securely within a vehicle cup holder.

31. The power inverter of claim 23, wherein the one or more electrical interfaces are output electrical interfaces, the device further comprising one or more input electrical interfaces on the exterior surface of the upper portion of the housing, the one or more output electrical interfaces being adapted to electrically couple with and input a signal from an external power source.

32. The power inverter of claim 23, further comprising a cooling fan secured within the upper portion of the housing adjacent an upper surface of the housing, the upper surface of the housing further comprising one or more vents.

33. A portable power supply, comprising:
means for converting direct current into alternating current;
means for housing the means for converting direct current into alternating current, wherein the means for housing is configured to fit within a cup holder;
means for electrically coupling the means for converting direct current into alternating current with a power source; and
means for electrically coupling the means for converting direct current into alternating current with an electrical device to be powered.
